(19) United States
(12) Patent Application Publication
(10) Pub. No.: US 2020/0176762 A1
(43) Pub. Date: Jun. 4, 2020

(54) ELECTRON CONDUCTIVE POLYMER COMPOSITES AND THEIR USE AS ELECTRODE MATERIALS

(71) Applicant: UT-Battelle, LLC, Oak Ridge, TN (US)

(72) Inventors: Xiao-Guang Sun, Knoxville, TN (US); Sheng Dai, Knoxville, TN (US); Hailong Lyu, Knoxville, TN (US)

(21) Appl. No.: 16/207,395

(22) Filed: Dec. 3, 2018

(51) Int. Cl. H01M 4/36; H01M 10/0525; H01M 4/62; H01M 4/60; H01G 11/48; H01G 11/58; C08L 79/08

(52) U.S. Cl. CPC H01M 4/366; H01M 10/0525; H01M 4/624; H01M 2004/028; H01G 11/48; H01G 11/58; C08L 79/08; H01M 4/608

(57) ABSTRACT

A composite material comprising particles containing (i) a core comprising an organic polymer material that is ion-permeable, not electron conductive, and possesses reversible electrochemical activity (e.g., aromatic polyimide, polyquinone, and radical-containing polymers), and (ii) an electron conductive polymer (e.g., polythiophene, poly(3,4-ethylenedioxythiophene), polypyrrole, polyaniline, polyacetylene, or poly(p-phenylene vinylene), alkyl-substituted derivatives thereof, hydrophilized derivatives thereof, or copolymer thereof) coated onto and encapsulating the core. Also described herein are batteries (e.g., lithium-ion) in which at least the cathode contains the composite material described above. Also described herein are capacitors in which at least one electrode contains the composite material described above.

This invention was made with government support under Prime Contract No. DE-AC05-00OR22725 awarded by the U.S. Department of Energy. The government has certain rights in the invention.

### FIELD OF THE INVENTION

The present invention generally relates to organic electrode materials useful in such applications as batteries, capacitors, transistors, and photovoltaic devices. The present invention more particularly relates to electrodes in which conductive polymer compositions are incorporated, and to devices containing such conductive polymer compositions.

### BACKGROUND OF THE INVENTION

Although conventional lithium-ion batteries (LIBs) based on inorganic cathodes are utilized in a wide range applications, they still have a number of disadvantages, including safety problems and less than desirable power density and sustainability. Therefore, efforts have been directed to finding alternative, more environmentally friendly, and naturally abundant cathode materials for LIBs. As a result, renewable organic electrodes, such as organosulfur compounds, organic radical polymers, conducting polymers, and organic carbonyl compounds have been intensively investigated. These organic materials have some unique properties that are generally not shared with inorganic cathode materials. In particular, due to the light weight, flexibility, and chemical tunability of organic electrode materials, they are generally more flexible and safer to operate. Of further significance, as organic electrode materials generally do not include toxic heavy metal elements, they can be more easily recycled with lower environmental impact. Nevertheless, serious obstacles remain for practical application of the organic electrodes, such as poor rate capability due to their low electronic conductivity and rapid capacity fading during cycling due to the dissolution of the active organic cathodes (e.g., P. Sharma, et al., J. Phys. Chem. Lett., 2013, 4, 3192-3197 and M. Lee, et al., Adv. Mater., 2014, 26, 2558-2565).

Among different organic cathodes, aromatic polyimide is a very promising candidate with a theoretical capacity approaching 400 mA h g⁻¹ and a working voltage around 2.5 V vs. Li/Li⁺ (e.g., Z. Song, et al., Angew. Chem. Int. Ed., 2010, 49, 8444-8448). During the discharge process (lithium intake), aromatic polyimide can stepwise accept two electrons, resulting in the formation of a delocalized radical anion and dianion, as shown in FIG. 1. Although two more electrons can be accepted during the discharge process, the lower redox potential coupled with poor structure stability usually prevent such a process (e.g., X. Y. Han, et al., Angew. Chem. Int. Ed. 2012, 51, 5147-5151). In contrast to lithium intercalation in inorganic cathodes, the lithium storage mechanism in aromatic polyimides is a simple redox reaction, which facilitates fast lithium kinetics (e.g., Y. Liang, et al., Adv. Energy Mater., 2012, 2, 742-769). To overcome the intrinsic electrical insulation of aromatic polyimides and obtain high rate performance, expensive carbon additives, such as graphene or carbon nanotubes, have been conventionally used for electrode fabrication. However, a large amount of conductive carbon additives limits the loading of the active polyimide materials in the cathode and significantly increases the cost of the electrodes.

### SUMMARY OF THE INVENTION

In one aspect, the present disclosure is directed to a composite material containing particles composed of (i) a core containing an organic polymer material that is ion-permeable, not electron conductive, and possesses reversible electrochemical activity, and (ii) an electron conductive polymer coated onto and encapsulating the core. The present disclosure is also directed to metal-ion batteries, particularly lithium-ion batteries, in which the above-described composite material is incorporated into at least a cathode of the metal-ion battery. As further discussed below, lithium-ion batteries containing this composite material in the cathode have been shown to exhibit an exceptionally high reversible capacity along with a high-rate cycling stability. The present disclosure is also directed to other electrode-containing devices (e.g., capacitors, transistors, and photovoltaic devices) in which the composite material is incorporated into at least one electrode thereof.

The present disclosure is particularly directed, in some embodiments, to a polymer composite based on particles of aromatic polyimide (PI) coated with conductive polythiophene (PT). As shorthand, the foregoing composite can be denoted as PI@PT. The composite can be conveniently prepared by a facile in situ chemical oxidation polymerization approach. Besides providing outstanding electronic conductivity for the polymer composite, the PT coating has also been found to act as an ionic adsorbent and protective shell for the composite material because of its good electrochemical stability. Overall, as further discussed below, the PI@PT composite demonstrates high capacity, long cycle stability, and good rate performance in rechargeable LIBs. Significantly, the common aromatic structure possessed in both electroactive PI and electron conductive PT permits intimate contacts, which results in conductive polymeric composites with highly reversible redox reactions and good structure stability. It has herein been particularly demonstrated that the PI composite material with 30 wt. % PT coating (i.e., “PI30PT”) possesses an optimal combination of good electronic conductivity and fast lithium reaction kinetics. The synergistic effect between PI and PT provides a high reversible capacity of 216.8 mA h g⁻¹ at a current rate of C/10, as well as a high-rate cycling stability; that is, a high capacity of 89.6 mA h g⁻¹ at a high current rate of 20 C with a capacity retention of 94% after 1000 cycles. The advantageous combination of high electronic conductivity of the PT coating and superior redox reaction reversibility of the PI matrix offers an economic way to produce high performance lithium-ion batteries for sustainable energy storage applications.

### BRIEF DESCRIPTION OF THE DRAWINGS

The patent or application contains at least one drawing executed in color. Copies of this patent or patent application publication with color drawing(s) will be provided by the Patent and Trademark Office upon request and payment of the necessary fee.

FIG. 1 is a reaction scheme showing the electrochemical redox reactions of polyimide (PI).

FIGS. 2a-2e are photographs of powders of polyimide (FIG. 2a); polyimide coated with 10 wt % polythiophene (i.e., PI10PT, FIG. 2b); polyimide coated with 30 wt % polythiophene (i.e., PI30PT, FIG. 2c); polyimide coated with 50 wt % polythiophene (i.e., PI50PT, FIG. 2d); and polythiophene (FIG. 2e). FIG. 2f shows FTIR spectra of each of the powders shown in FIGS. 2a-2e.

FIGS. 3a-3e are scanning electron microscopy (SEM) images of the surface morphologies of powders of: polyimide (FIG. 3a); polyimide coated with 10 wt % polythiophene (i.e., PI10PT, FIG. 3b); PI30PT (FIG. 3c); PI50PT (FIG. 3d); and polythiophene (FIG. 3e).

FIG. 4a contains six panels of SEM images of PI30PT as follows: SEM image (top left), SEM image with total energy-dispersive x-ray spectroscopy (EDS) mapping of C, N, O, and S elements (top middle); SEM image with EDS mapping of C (top right); SEM image with EDS mapping of N (bottom left); SEM image with EDS mapping of O (bottom middle); and SEM image with EDS mapping of S (bottom right). FIG. 4b shows EDS spectra of PT, PI, PI10PT, PI30PT and PI50PT.

FIG. 5a shows cyclic voltammograms (CV) of PI, PI10PT, PI30PT and PI50PT at a scan rate of 0.05 mV s⁻¹. FIG. 5b shows charge-discharge profiles of PI, PI10PT, PI30PT and PI50PT at a current rate of C/10.

FIG. 6a shows charge-discharge capacities and coulombic efficiencies of the half-cells based on PI, PI10PT, PI30PT and PI50PT at different current rates. FIG. 6b shows charge-discharge capacities and coulombic efficiencies of the half-cells based on PI, PI10PT, PI30PT and PI50PT at a current rate of C/2. FIG. 6c shows electrochemical impedance spectra of the half-cells based on PI, PI1 OPT, PI30PT and PI50PT before cycling. FIG. 6d shows electrochemical impedance spectra of the half-cells based on PI, PI10PT, PI30PT and PI50PT after 300 cycles at C/2. FIG. 6e shows charge-discharge capacities and coulombic efficiencies of the half-cells based on PI30PT at different current rates (hollow circles and solid spheres represent charge and discharge capacities, respectively, while hollow stars represent coulombic efficiencies in FIGS. 6a, 6b and 6e).

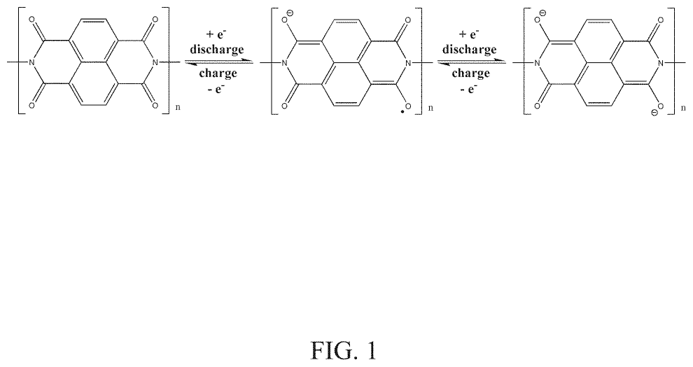

### DETAILED DESCRIPTION OF THE INVENTION

The composite particles contain a core composed of an organic polymer material that is ion-permeable, yet not electron conductive, and possesses reversible electrochemical activity. In some embodiments, the core polymer material contains carbonyl groups, and more particularly, conjugated carbonyl groups. Generally, the carbonyl groups are within a ring, and the carbonyl groups in the ring are often conjugated with aromatic (e.g., phenyl or heteroaryl) rings fused to the ring containing the one or more carbonyl groups. The carbonyl groups may or may not be located on adjacent carbon atoms, i.e., as a —C(O)—C(O)— moiety in the ring. The carbonyl groups may or may not also be connected with a nitrogen atom to form a polyimide. The carbonyl groups may or may not also be part of quinone rings.

The term “particles,” as used herein, generally refers to discrete pieces of the composite material having an average diameter of no more than about 1 mm. The particles may, in some embodiments, have an approximately spherical shape. In other embodiments, the particles have a less defined globular shape. In some embodiments, the particles have an average diameter in the micron range, e.g., 1, 2, 5, 10, 20, 50, 100, or 500 microns, or a size within a range bounded by any two of the foregoing values. In other embodiments, the particles have an average diameter in the nanometer range, e.g., 1, 2, 5, 10, 20, 50, 100, or 500 nm, or a size within a range bounded by any two of the foregoing values. In some embodiments, the minimum and maximum sizes are within the micron range, or the minimum and maximum sizes are within the nanometer range, or the minimum and maximum sizes span the micron and nanometer range.

In a first set of embodiments, the core polymer material is an aromatic polyimide. The term “aromatic polyimide,” as used herein, refers to polymers containing a carbonyl-imino-carbonyl (i.e., —C(═O)N—C(═O)—) moiety within an aromatic ring or ring system. The aromatic polyimide can be more particularly described by the following structure:

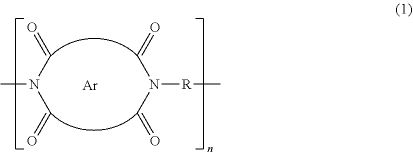

In Formula (1) above, Ar represents an aromatic ring or ring system within the bounds of the two arcs depicted in Formula (1), each arc representing one or more bonds within the aromatic ring or ring system and which are connected to the carbonyl groups depicted in Formula (1). In particular embodiments, Ar represents an aromatic ring system containing precisely or at least two, three, four, five, or six aromatic rings fused together. The group R represents a bond or a hydrocarbon linking group linking the imide nitrogen atoms in Formula (1). As a hydrocarbon linking group, R may be, for example, a linear or branched alkylene linking group (e.g., methylene, ethylene, propylene, butylene, pentylene, or hexylene, i.e., of the general formula —(CH₂)ᵣ, where r is 1-12, and one or both H atoms may be replaced by a hydrocarbon group); or R may be an alkenylene group containing 2-12 carbon atoms and at least one carbon-carbon double or triple bond; or R may be or include a saturated, or aliphatic, or aromatic or heteroaromatic ring; and n represents an integer of at least or above 10, 12, 15, 20, 30, 40, 50, or 100.

Some exemplary aromatic polyimide structures considered herein include the following:

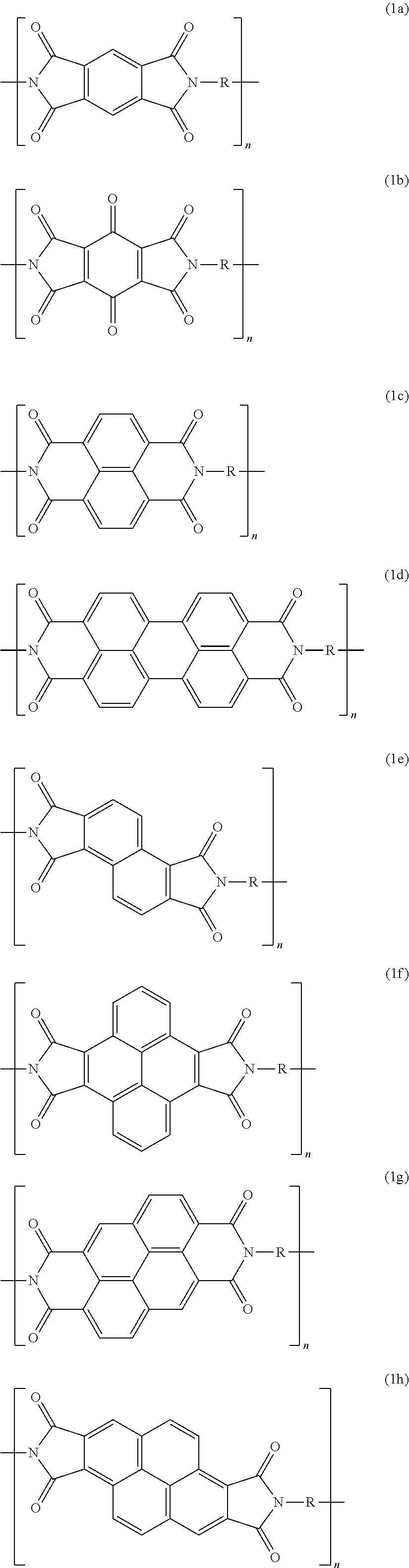

In a second set of embodiments, the core polymer material is a polyquinone. The term “polyquinone,” as used herein, refers to polymers containing a multiplicity of quinone groups, wherein a quinone group refers to a cyclohexane, cyclohexene, or cyclohexadiene ring containing two ring carbonyl groups oriented para to each other. Some examples of polyquinones are disclosed in Z. Song et al., Energy Environ. Sci., 6, 2280-2301, 2013, the contents of which are herein incorporated by reference. Some examples of polyquinones include the following:

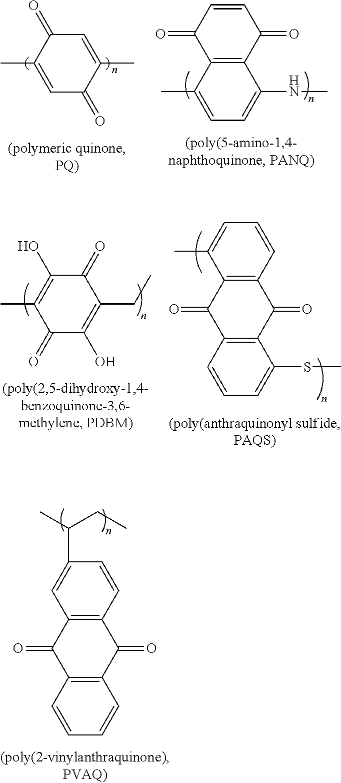

An example of a conjugated carbonyl polymer that is neither a quinone nor a polymide includes the following:

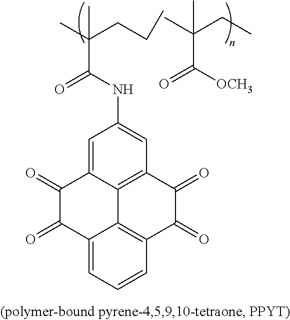

In a third set of embodiments, the core polymer material is a radical-containing polymer. Some examples of radical-containing polymers are disclosed in K. Zhang et al., Polym. Chem., 7, 5589-5614, 2016; Z. Song et al., Energy Environ. Sci., 6, 2280-2301, 2013; and E. P. Tomlinson et al., Macromolecules, 47(18), 6145-6158, 2014, the contents of which are herein incorporated by reference in their entirety. In some embodiments, the radical-containing polymers are nitroxyl radical polymers. The radical-containing polymer may also be, for example, a phenoxyl radical polymer, triphenylmethyl radical polymer, or verdazyl radical polymer, all of which are described in detail in, for example, K. Zhang et al. (supra).

Some examples of nitroxyl radical polymers include the following:

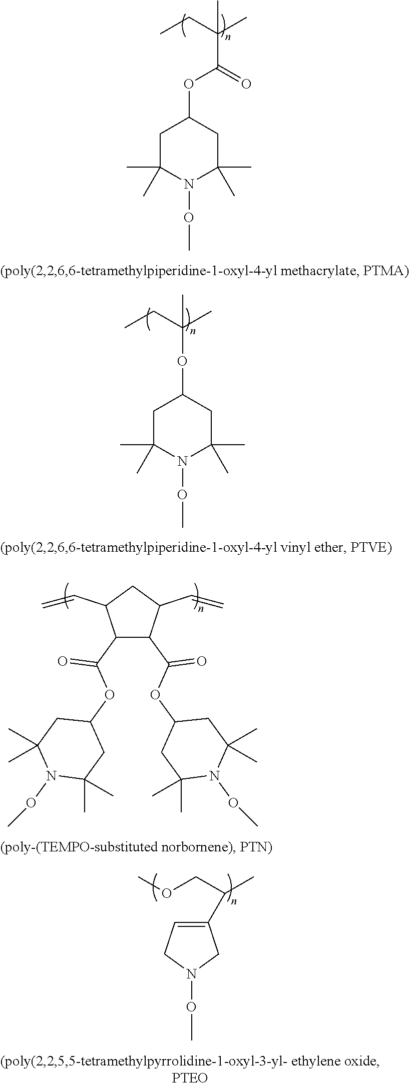

The composite particles also contain an electron conductive polymer (also referred to as a “conductive polymer”) coated onto and encapsulating the core described above. Conductive polymers are well known in the art, such as described in T.-H. Le et al., Polymers, 9, 150, 2017, the contents of which are herein incorporated by reference. Generally, a conductive polymer possesses a conductivity on the order of a metal. For this reason, conductive polymers are sometimes referred to as “synthetic metals”. As well known, the electron conductive polymer generally contains conjugated unsaturated bonds through the length of the polymer, and this functions to transfer electrons across the polymer. In some embodiments, the conductive polymer is doped (e.g., n- or p-doped) to render the polymer sufficiently conductive to qualify as a conductive polymer.

Although the conductive polymer encapsulates (surrounds) the core, it has herein been found advantageous for the conductive polymer to be coated on the core below a threshold thickness where porosity is substantially diminished (i.e., the thickness of the conductive polymer should be thin enough to maintain some level of porosity). In this respect, it has herein been found that a suitable level of porosity in the conductive polymer is provided when the conductive polymer is deposited on the core in an amount of no more than or less than 30, 35, 40, 45, or 50 wt % by total weight of the conductive polymer and core, or within a range bounded by any two of the foregoing values. The conductive polymer is typically coated on the core in an amount of at least or above 1, 2, 5, or 10 wt %. In various embodiments, the conductive polymer is coated on the core in an amount of 1, 2, 5, 10, 15, 20, 25, 30, 35, 40, 45, or 50 wt %, or an amount within a range bounded by any two of the foregoing values, e.g., 1-30 wt %, 1-35 wt %, 1-40 wt %, 1-45 wt %, 1-50 wt %, 2-30 wt %, 2-35 wt %, 2-40 wt %, 2-45 wt %, 2-50 wt %, 5-30 wt %, 5-35 wt %, 5-40 wt %, 5-45 wt %, 5-50 wt %, 10-30 wt %, 10-35 wt %, 10-40 wt %, 10-45 wt %, or 10-50 wt %.

In some embodiments, the conductive polymer is aromatic. Some examples of such conductive polymers include polythiophene, poly(3,4-ethylenedioxythiophene), polypyrrole, polyaniline, poly(p-phenylene vinylene), and poly(3-vinylperylene). The conductive polymer may also be an alkyl-substituted derivative of any of the foregoing examples. Some examples of alkyl-substituted conductive polymers include poly(3-methylthiophene), poly(3-hexylthiophene), and poly[2,5-bis(3-tetradecylthiophen-2-yl)thieno[3,2-b]thiophene](i.e., PBTTT-C14). The conductive polymer may also be a copolymer containing at least two blocks of different conductive polymers. The copolymer may be, for example, a block, alternating, or brush copolymer. An example of a conductive copolymer is polyaniline-polypyrrole (PANI/PPy) copolymer, such as described in K. He et al., J. Appl. Polym. Sci., 135, 46289, 2018, the contents of which are herein incorporated by reference. The conductive polymer may also be derivatized with polar (or more particularly, hydrophilic) groups, such as nitrile, hydroxy, methoxy, ethoxy, carboxylic acid, carboxylic acid ester, amine, amide, sulfonate, nitro, or halogen groups. Some examples of hydrophilized conductive polymers include sodium poly(2-(3-thienyloxy)ethanesulfonate) and sodium poly(2-(4-methyl-3-thienyloxy)ethanesulfonate, such as described in M. Chayer et al., Chem. Mater., 9(12), 2902-2905, 1997, the contents of which are herein incorporated by reference. In some embodiments, the conductive polymer is not aromatic. An example of such a conductive polymer is polyacetylene.

In another aspect, the invention is directed to a metal-ion battery containing any of the composite materials described above in at least the cathode (positive charge on discharge) of the battery. In the metal-ion battery, a suitable electrolyte is in contact with positive and negative electrodes of the battery. The metal-ion battery can have a rechargeable or non-rechargeable design, but is more typically a rechargeable metal-ion battery.

In particular embodiments, the invention is directed to a lithium-ion battery containing the above-described composite material in at least the cathode (on discharge) of the battery. Lithium-ion batteries are well known in the art. The lithium-ion battery may contain any of the components typically found in a lithium ion battery, including positive and negative electrodes (i.e., cathode and anode, respectively), current collecting plates, and a battery shell, such as described in, for example, U.S. Pat. Nos. 8,252,438, 7,205,073, and 7,425,388, the contents of which are incorporated herein by reference in their entirety.

The negative electrode (anode) may include any suitable composition that can function as a negative electrode in a battery. In some embodiments, the negative electrode also includes the composite material described above. In other embodiments, the negative electrode contains a conventional anodic material either in place of or in combination (e.g., in admixture) with the composite material. The negative electrode may include any of the carbon-containing and/or silicon-containing anode materials well known in the art of lithium-ion batteries. The carbon-containing composition is typically one in which lithium ions can intercalate or embed, such as graphite (e.g., natural or artificial graphite), petroleum coke, carbon fiber (e.g., mesocarbon fibers), carbon (e.g., mesocarbon) microbeads, fullerenes (e.g., carbon nanotubes, i.e., CNTs), and graphene. The silicon-containing composition, which may be used in the absence or presence of a carbon-containing composition in the anode, can be any of the silicon-containing compositions known in the art for use in lithium-ion batteries. Lithium-ion batteries containing a silicon-containing anode may alternatively be referred to as lithium-silicon batteries. The silicon-containing composition may be, for example, in the form of a silicon-carbon (e.g., silicon-graphite, silicon-carbon black, silicon-CNT, or silicon-graphene) composite, silicon microparticles, or silicon nanoparticles, including silicon nanowires. The negative electrode may also be a metal oxide, such as tin dioxide (SnO₂) or titanium dioxide (TiO₂), or a composite of carbon and a metal oxide. The lithium-ion battery may also be a lithium-sulfur battery, wherein sulfur and/or lithium sulfides may be admixed at the cathode with the composite material described above.

The positive electrode (cathode) includes or is composed exclusively of the composite material described above. In some embodiments, the cathode includes a conventional cathode material admixed with the composite material. The conventional cathode material can be, for example, manganese dioxide (MnO₂), iron disulfide (FeS₂), copper oxide (CuO), or a lithium metal oxide, wherein the metal is typically a transition metal, such as Co, Fe, Ni, or Mn, or combination thereof. Some examples of lithium metal oxides include LiCoO₂, LiNiCoO₂, LiMnO₂, and LiFePO₄. Recently, with an effort to increase the energy density of the LIBs, 5.0V positive electrode materials, such as LiNi_{0.5}Mn_{1.5}O₄, LiNiₓCo₁₋ₓPO₄, and LiCuₓMn₂₋ₓO₄, have been developed (Cresce, A. V., et al., Journal of the Electrochemical Society, 2011, 158, A337-A342). To improve conductivity at the positive electrode, conductive carbon material (e.g., carbon black, carbon fiber, or graphite) is often admixed with the positive electrode material. In some embodiments, any one or more classes or specific types of conventional cathode materials are excluded from the cathode.

The positive and negative electrode compositions are often admixed with an adhesive (e.g., PVDF, PTFE, and co-polymers thereof) in order to gain the proper viscosity and density for molding as electrodes. A conductive substance (e.g., a conductive carbon) may or may not also be included. Typically, positive and negative current collecting substrates (e.g., Cu or Al foil) are also included. The assembly of lithium-ion batteries is well known in the art.

Sodium-ion batteries are also well known in the art, such as described in, for example, U.S. Application Publication No. 2012/0021273, and B. L. Ellis, et al., Current Opinion in Solid State and Materials Science, 16, 168-177, 2012, the contents of which pertaining to sodium-ion batteries are herein incorporated by reference in their entirety. The sodium-ion battery may employ the composite material in at least the cathode. The sodium-ion battery may alternatively employ the composite material in admixture with a sodium inorganic material as the active material in the cathode. Some examples of sodium inorganic materials include, for example, NaFeO₂, NaMnO₂, NaNiO₂, and NaCoO₂. Other cathode materials for sodium-ion batteries include transition metal chalcogenides, such as described in U.S. Pat. No. 8,906,542, and sodium-lithium-nickel-manganese oxide materials, such as described in U.S. Pat. No. 8,835,041, the contents of which are herein incorporated by reference.

The lithium-ion battery may also include a solid porous membrane positioned between the negative and positive electrodes. The solid porous membrane can be composed of, for example, a plastic or polymeric material (e.g., polyethylene, polypropylene, or copolymer thereof) or an inorganic material, such as a transition metal oxide (e.g., titania, zirconia, yttria, hafnia, or niobia) or main group metal oxide, such as silicon oxide, which can be in the form of glass fiber.

As well known in the art, the lithium-ion battery typically also includes a lithium-containing electrolyte. In the case of a lithium-ion battery, the electrolyte contains a lithium salt. The lithium salt can, in one embodiment, be non-carbon-containing (i.e., inorganic) by having an inorganic counteranion. The inorganic counteranion can be, for example, a halide (e.g., chloride, bromide, or iodide), hexachlorophosphate (PCl₆⁻), hexafluorophosphate (PF₆⁻), perchlorate, chlorate, chlorite, perbromate, bromate, bromite, periodate, iodate, aluminum fluorides (e.g., AlF₄⁻), aluminum chlorides (e.g., Al₂Cl₇⁻ and AlCl₄⁻), aluminum bromides (e.g., AlBr₄⁻), nitrate, nitrite, sulfate, sulfite, phosphate, phosphite, arsenate, hexafluoroarsenate (AsF₆⁻), antimonate, hexafluoroantimonate (SbF₆⁻), selenate, tellurate, tungstate, molybdate, chromate, silicate, the borates (e.g., borate, diborate, triborate, tetraborate), tetrafluoroborate, anionic borane clusters (e.g., B₁₀H₁₁²⁻ and B₁₂H₁₂²⁻), perrhenate, permanganate, ruthenate, perruthenate, and the polyoxometalates.

In another embodiment, the lithium salt is carbon-containing (i.e., organic) by including an organic counteranion. The organic counteranion may, in one embodiment, lack fluorine atoms. The organic counteranion can be, for example, carbonate, the carboxylates (e.g., formate, acetate, propionate, butyrate, valerate, lactate, pyruvate, oxalate, malonate, glutarate, adipate, decanoate, and the like), the sulfonates (e.g., CH₃SO₃⁻, CH₃CH₂SO₃⁻, CH₃(CH₂)₂SO₃⁻, benzenesulfonate, toluenesulfonate, dodecylbenzenesulfonate, and the like), the alkoxides (e.g., methoxide, ethoxide, isopropoxide, and phenoxide), the amides (e.g., dimethylamide or diisopropylamide), diketonates (e.g., acetylacetonate), the organoborates (e.g., BR₁R₂R₃R₄⁻, wherein R₁, R₂, R₃, R₄ are typically hydrocarbon groups containing 1 to 6 carbon atoms), anionic carborane clusters, alkylsulfates (e.g., diethylsulfate), alkylphosphates (e.g., ethylphosphate or diethylphosphate), dicyanamide (i.e., N(CN)₂⁻), tricyanamide (i.e., N(CN)₃⁻), and the phosphinates (e.g., bis-(2,4,4-trimethylpentyl)phosphinate). The organic counteranion may, in another embodiment, include fluorine atoms. For example, the lithium-containing species can be a lithium ion salt of such counteranions as the fluorosulfonates (e.g., CF₃SO₃⁻, CF₃CF₂SO₃⁻, CF₃(CF)₂SO₃⁻, CHF₂CF₂SO₃⁻, and the like), the fluoroalkoxides (e.g., CF₃O⁻, CF₃CH₂O⁻, CF₃CF₂O⁻, and pentafluorophenolate), the fluorocarboxylates (e.g., trifluoroacetate and pentafluoropropionate), and the fluorosulfonylimides (e.g., (CF₃SO₂)₂N⁻). In some embodiments, any one or more classes or specific types of lithium salts are excluded from the electrolyte. In other embodiments, a combination of two or more lithium salts are included in the electrolyte.

In the case of a sodium-ion battery, the electrolyte contains a sodium salt. The sodium salt can be any of the sodium salts known to be useful in the art of sodium-ion batteries. Some examples of sodium salts include NaClO₄, NaPF₆, NaAsF₆, NaSbF₆, NaBF₄, NaCF₃SO₃, NaAlCl₄, or NaN(SO₂CF₃)₂).

The metal salt is incorporated in the electrolyte in an amount that imparts a sufficient concentration of metal ions and resulting suitable level of conductivity to the electrolyte. The conductivity of the electrolyte can be, for example, at least 0.01 mS/cm (0.001 S/m) at an operating temperature of interest, and particularly at a temperature within 20-60° C. The metal salt is typically present in an amount of at least or above 0.1 M concentration in the electrolyte. In different embodiments, the metal salt is present in the electrolyte in a concentration of about, at least, above, up to, or less than, for example, 0.5, 1.0, 1.2, 1.5, 1.8, 2, 2.5, or 3 M.

In one embodiment, the solvent in the electrolyte is an organic solvent. The term “organic solvent,” as used herein, refers to any non-ionic carbon-containing solvent known in the art. The organic solvent typically has a melting point up to or less than 100, 90, 80, 70, 60, or 50° C., and more typically, below room temperature, i.e., below about 25° C., and more typically, up to or less than 20, 15, 10, 5, or 0° C. The organic solvent, which is typically also an aprotic polar solvent, can be, for example, a carbonate, sulfone, siloxane, silane, ether, ester, nitrile, sulfoxide, or amide solvent, or a mixture thereof.

Some examples of carbonate solvents include propylene carbonate (PC), ethylene carbonate (EC), butylene carbonate (BC), chloroethylene carbonate, fluorocarbonate solvents (e.g., fluoroethylene carbonate and trifluoromethyl propylene carbonate), as well as the dialkylcarbonate solvents, such as dimethyl carbonate (DMC), diethyl carbonate (DEC), dipropyl carbonate (DPC), ethyl methyl carbonate (EMC), methyl propyl carbonate (MPC), and ethyl propyl carbonate (EPC). Some examples of sulfone solvents include methyl sulfone, ethyl methyl sulfone, methyl phenyl sulfone, methyl isopropyl sulfone (MiPS), propyl sulfone, butyl sulfone, tetramethylene sulfone (sulfolane), phenyl vinyl sulfone, allyl methyl sulfone, methyl vinyl sulfone, divinyl sulfone (vinyl sulfone), diphenyl sulfone (phenyl sulfone), dibenzyl sulfone (benzyl sulfone), vinylene sulfone, butadiene sulfone, 4-methoxyphenyl methyl sulfone, 4-chlorophenyl methyl sulfone, 2-chlorophenyl methyl sulfone, 3,4-dichlorophenyl methyl sulfone, 4-(methylsulfonyl)toluene, 2-(methylsulfonyl)ethanol, 4-bromophenyl methyl sulfone, 2-bromophenyl methyl sulfone, 4-fluorophenyl methyl sulfone, 2-fluorophenyl methyl sulfone, 4-aminophenyl methyl sulfone, a sultone (e.g., 1,3-propanesultone), and sulfone solvents containing ether groups (e.g., 2-methoxyethyl(methyl)sulfone and 2-methoxyethoxyethyl(ethyl)sulfone). Some examples of siloxane solvents include hexamethyldisiloxane (HMDS), 1,3-divinyltetramethyldisiloxane, the polysiloxanes, and polysiloxane-polyoxyalkylene derivatives. Some examples of silane solvents include methoxytrimethylsilane, ethoxytrimethylsilane, dimethoxydimethylsilane, methyltrimethoxysilane, and 2-(ethoxy)ethoxytrimethylsilane. Some examples of ether solvents include diethyl ether, 1,2-dimethoxyethane, 1,2-diethoxyethane, 1,3-dioxolane, tetrahydrofuran, 2-methyltetrahydrofuran, tetrahydropyran, diglyme, triglyme, 1,3-dioxolane, a dioxane, and the fluorinated ethers (e.g., mono-, di-, tri-, tetra-, penta-, hexa- and per-fluoro derivatives of any of the foregoing ethers). Some examples of ester solvents include 1,4-butyrolactone, ethylacetate, methylpropionate, ethylpropionate, propylpropionate, methylbutyrate, ethylbutyrate, the formates (e.g., methyl formate, ethyl formate, or propyl formate), and the fluorinated esters (e.g., mono-, di-, tri-, tetra-, penta-, hexa- and per-fluoro derivatives of any of the foregoing esters). Some examples of nitrile solvents include acetonitrile, propionitrile, and butyronitrile. Some examples of sulfoxide solvents include dimethyl sulfoxide, ethyl methyl sulfoxide, diethyl sulfoxide, methyl propyl sulfoxide, and ethyl propyl sulfoxide. Some examples of amide solvents include formamide, N,N-dimethylformamide, N,N-diethylformamide, acetamide, dimethylacetamide, diethylacetamide, gamma-butyrolactam, and N-methylpyrrolidone. The non-ionic solvent can be included in a non-additive or additive amount, such as any of the exemplary amounts provided above for the ionic liquids. The non-ionic solvent may also be, for example, an organochloride (e.g., methylene chloride, chloroform, 1,1,-trichloroethane), ketone (e.g., acetone, 2-butanone), hexamethylphosphoramide (HMPA), N-methylpyrrolidinone (NMP), 1,3-dimethyl-3,4,5,6-tetrahydro-2(1H)-pyrimidinone (DMPU), and propylene glycol monomethyl ether acetate (PGMEA). In some embodiments, any one or more classes or specific types of organic solvents are excluded from the electrolyte.

In another embodiment, the solvent in the electrolyte is an ionic liquid. The ionic liquid can be conveniently described by the formula Y⁺X⁻, wherein Y⁺ is a cationic component of the ionic liquid and X⁻ is an anionic component (counteranion) of the ionic liquid, which can be any of the counteranions well known in the art and as provided above for the metal salts. The formula (Y⁺)(X⁻) is meant to encompass a cationic component (Y⁺) having any valency of positive charge, and an anionic component (X⁻) having any valency of negative charge, provided that the charge contributions from the cationic portion and anionic portion are counterbalanced in order for charge neutrality to be preserved in the ionic liquid molecule. More specifically, the formula (Y⁺)(X⁻) is meant to encompass the more generic formula (Y^{-a})_{y}(X^{-b})ₓ, wherein the variables a and b are, independently, non-zero integers, and the subscript variables x and y are, independently, non-zero integers, such that a·y=b·x (wherein the period placed between variables indicates multiplication of the variables). The foregoing generic formula encompasses numerous possible sub-formulas, such as, for example, (Y⁺)(X⁻), (Y⁺²)(X⁻)₂, (Y⁺)₂(X⁻²), (Y⁺²)₂(X⁻²)₂, (Y⁺³)(X⁻)₃, (Y⁺)₃(X⁻³), (Y⁺³)₂(X⁻²)₃, and (Y⁺²)₃(X⁻³)₂. For simplicity, numerous embodiments of ionic liquids, described below, designate the anion as X⁻, which in its strict sense indicates a monovalent anion. However, the anion designated as X⁻ is meant to encompass an anion of any valency, such as any of the valencies described above and further below, unless otherwise specified. In some embodiments, Y⁺ can be a metal cation (e.g., an alkali metal, such as Li⁺), while in other embodiments Y⁺ is not a metal cation. In some embodiments, Y⁺ can be an inorganic species, while in other embodiments, Y⁺ is an organic species.

The ionic liquid is typically a liquid at room temperature (e.g., 15, 18, 20, 22, 25, or 30° C.) or lower. However, in some embodiments, the ionic liquid may become a liquid at a higher temperature than 30° C. if it is used at an elevated temperature that melts the ionic liquid. Thus, in some embodiments, the ionic liquid may have a melting point of up to or less than 100, 90, 80, 70, 60, 50, 40, or 30° C. In other embodiments, the ionic liquid is a liquid at or below 10, 5, 0, −10, −20, −30, or −40° C.

In various embodiments, the cationic portion (Y⁺) of the ionic liquid Y⁺X⁻ is selected from imidazolium, pyridinium, pyrazinium, pyrrolidinium, piperidinium, piperazinium, morpholinium, pyrrolium, pyrazolium, pyrimidinium, triazolium, oxazolium, thiazolium, and triazinium rings, as well as quaternary ammonium, phosphonium, sulfonium, and cyclic and acyclic guanidinium rings. Any of the foregoing cationic rings may be bound or fused with one or more other saturated or unsaturated (e.g., aromatic) rings, such as a benzene, cyclohexane, cyclohexene, pyridine, pyrazine, pyrrolidine, piperidine, piperazine, pyrrole, pyrazole, pyrimidine, or indole rings. Some examples of fused charged rings include benzimidazolium, pyrrolo[1,2-a]pyrimidinium, indolium, quinolinium, quinazolinium, quinoxalinium, 5,6,7,8-tetrahydroimidazo[1,2-a]pyridine, and H-imidazo[1,2-a]pyridine. Any of the foregoing cationic rings may also be substituted by one or more hydrocarbon groups. Typically, at least one ring nitrogen atom is substituted with a hydrocarbon group (R) to provide the positive charge. Ionic liquids containing any of the foregoing cationic components are either commercially available or can be synthesized by procedures well-known in the art, as evidenced by, for example, T. L. Greaves, et al., “Protic Ionic Liquids: Properties and Applications”, Chem. Rev., 108, pp. 206-237 (2008), the contents of which are herein incorporated by reference. Any of the ionic liquids described in the foregoing reference may be used herein.

The liquid electrolyte may alternatively have an inorganic composition (i.e., an absence of carbon). An example of such a liquid electrolyte is a mixture of thionyl chloride (SOCl₂) and lithium tetrachloroaluminate (LiAlCl₄), as used in some lithium batteries.

In another aspect, the invention is directed to a capacitor that contains two electrodes, at least one of which contains the composite material described above. As well known, the capacitor also includes an ion-permeable membrane between the two electrodes and an electrolyte in contact with the two electrodes. The capacitor may also be referred to as an “electrochemical capacitor” (EC) or “electrochemical double-layer capacitor” (EDLC or “supercapacitor”), such as described in Y. Zhang et al., International Journal of Hydrogen Energy, 34(11), 4889-4899, June 2009 and P. Sharma et al., Energy Conversion and Management, 51(12), 2901-2912, December 2010, the contents of which are herein incorporated by reference. In some embodiments, one or both electrodes are composed solely of the composite material described above. In other embodiments, one or both electrodes are composed of the composite material in admixture with a conventional capacitor electrode material, such as a carbon-containing material or transition metal oxide.

In another aspect, the invention is directed to a method of producing the composite material described above. Any method capable of producing core-shell polymer particles are considered herein, provided the method is capable of depositing a conductive polymer onto an ion-permeable non-electron conductive polymer material possessing reversible electrochemical activity. In some embodiments, the conductive polymer is deposited onto the base core particles by placing the core particles within a liquid matrix containing a monomer precursor of the conductive polymer, followed by in situ polymerization of the monomer in the presence of the core particles with the result of growing (i.e., depositing) the conductive polymer onto the core particles. The polymerization method should be suited to the type of conductive polymer being produced and deposited. For example, in the case of depositing polythiophene, an in situ chemical oxidation polymerization method may be employed, as further discussed hereinbelow.

Examples have been set forth below for the purpose of illustration and to describe certain specific embodiments of the invention. However, the scope of this invention is not to be in any way limited by the examples set forth herein.

### Examples

### Synthesis of N,N′-diamino-1,4,5,8-naphthalenetetracarboxylic bisimide (DANTCBI)

As the intermediate, DANTCBI was synthesized via the substitution reaction between 1,4,5,8-naphthalenetetracarboxylic dianhydride (NTCDA, >98%) and hydrazine according to the following general scheme:

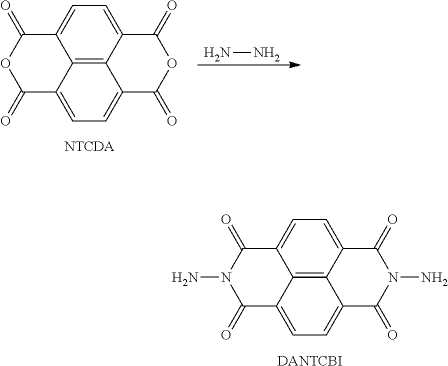

Specifically, NTCDA (10 g) and ethanol (200 ml) were added into an ice-cooled flask and stirred to achieve a homogeneous solution under a nitrogen atmosphere. Hydrazine hydrate (20 mL) was then added dropwise into the cold reaction mixture. After stirring for 1 hour, the mixture was heated to reflux for 1 hour. The resulting dark yellow solid was collected by filtration and dried in vacuum to obtain 10.6 g product in ˜96%0 yield. ¹H NMR (DMSO-d₆, 400 MHz): δ=5.86 ppm (s, 4H), δ=8.68 ppm (s, 4H).

Preparation of PI@PT composites

The precursor PI was synthesized by a simple condensation polymerization method. Equimolar NTCDA and DANTCBI were dissolved in warm 4-chlorophenol as solvent, followed by heating to reflux under nitrogen with stirring for 6 hours. The product was filtered, thoroughly washed with methanol, and finally dried at 120° C. under vacuum for 12 hours. The pristine PI was obtained by heat treatment at 350° C. under nitrogen for 8 hours. The PI@PT composites were synthesized by a typical in situ chemical oxidation polymerization approach. Well-grounded PI (1.8 g) and FeCl₃ (0.8 g) were uniformly dispersed in CHCl₃ by sonicating and stirring for 1 hour, and then a solution of thiophene (0.19 mL, equal to 10 wt. % in the final product) and CHCl₃ (30 ml) were added slowly. The reaction mixture was stirred for 10 hours at 0° C. under nitrogen. The product was washed several times with methanol and collected by filtration. Finally, the red-brown powder was obtained by drying at 80° C. under vacuum and designated as PI10PT. In similar fashion, the amount of thiophene was increased to 30 wt. % and 50 wt. %, while maintaining the weight ratio of thiophene to FeCl³ as 1:4, to obtain the products of PI30PT and PI50PT, respectively. As a baseline, pure PT was also synthesized following the same procedure without PI.

Characterization

¹H nuclear magnetic resonance (NMR) spectra were obtained on a Bruker® Advance 400 MHz spectrometer using DMSO-d6 as the solvent. The chemical structures of the polymer products were characterized by Fourier transform infrared (FTIR) spectroscopy. The morphologies and microstructures of the samples were observed on a Hitachi® HD-2000 scanning transmission electron microscope (STEM) operating at 200 kV. The elemental compositions of the polymer composites were analyzed by energy dispersive X-ray spectroscopy (EDS) on a SEM instrument with an EDAX accessory.

Electrochemical Measurements

Polymer composite electrodes were fabricated by casting well homogenized slurries of active material, C45, and polyvinylidene fluoride (PVDF) binder with a weight ratio of 6:3:1 in N-methylpyrrolidone (NMP) on aluminum foils. After solvent evaporation, the electrodes were cut into discs with a diameter of 12.7 mm and dried thoroughly under vacuum at 120° C. for 12 hours. Half-cells for electrochemical measurement were assembled with polymer composites as cathode, lithium metal foils as both counter and reference electrodes, Celgard® 2320 as separator and 1 M LiPF₆ dissolved in EC, DEC, and DMC (1:1:1 vol.) as electrolyte. Coin cells were assembled in an argon filled glove box with oxygen and moisture contents below 0.5 ppm. The coin cells were cycled galvanostatically at various current rates on a battery test system with a voltage range from 1.5 to 3.2 V. Cyclic voltammograms (CVs) were obtained on using a scan rate of 0.05 mV s⁻¹ in a voltage range of 1.5-3.2 V. Electrochemical impedance spectra (EIS) were measured with a 10 mV AC bias in a frequency range of 200 kHz to 10 mHz.

Results and Discussion

The PI@PT composites were synthesized by an in situ oxidation polymerization method. To ensure a homogeneous coating of PT on the surface of PI, the latter was grounded into a fine powder and well dispersed in chloroform in which the monomer (thiophene) was dissolved. The polymerized (polythiophene) surface coating was produced slowly in the presence of the FeCl₃ catalyst at a low temperature of 0° C.

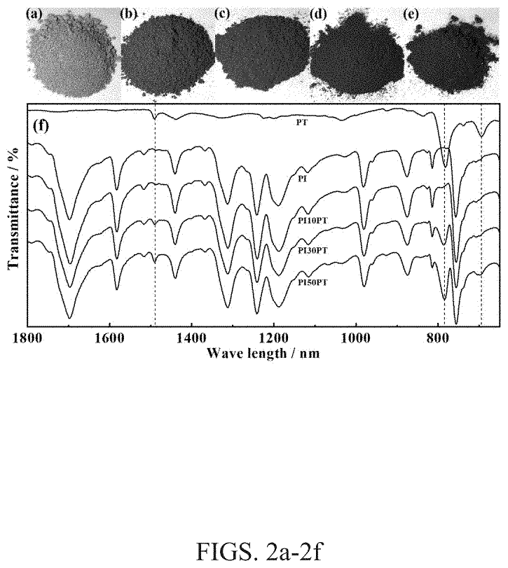

FIGS. 2a-2e are photographs of powders of polyimide (FIG. 2a); polyimide coated with 10 wt % polythiophene (i.e., PI10PT, FIG. 2b); PI30PT (FIG. 2c); PI50PT (FIG. 2d); and polythiophene (FIG. 2e). With increasing amount of PT, the color of the final product became darker, as shown in FIGS. 2a-2e, which indicates the successful coating of PI by PT. FIG. 2f shows FTIR spectra of each of the powders shown in FIGS. 2a-2e. As shown in FIG. 2f, for the pristine PT, the strongest absorption peak is at 782 cm⁻¹, which is attributed to the Cβ-H out-of-plane stretching vibration of the thiophene ring (F. Zhang, et al., Appl. Catal. B: Environ., 2014, 150-151. 472-478), which indicates a Cα-Cα connection of the thiophene rings in PT (F. Wu, et al., J. Phys. Chem. C, 2011, 115, 6057-6063). The Cα-Cα connection is important for conferring high electron conductivity and good electrochemical performance of the composites, as it has been shown that the Cα-Cα connected polythiophene exhibits the highest electron conductivity among different polythiophene structures (F. Wu, et al., Electrochem. Solid-State Lett., 2010, 13, A29). The weaker absorption peaks at 1490 and 694 cm⁻¹ of the PT can be assigned to the C—H and C—S stretching of the thiophene ring, respectively (L. Liu, et al., React. Funct. Polym., 2012, 72, 45-49; and E. Tahmasebi, et al., Anal. Chim. Acta, 2013, 770, 68-74). As for pure PI and those of PI@PT composites, the characteristic vibration absorptions of C═O and C—N at 1703 and 1318 cm⁻¹ are observed and fully consistent with the previously reported spectra, which indicates the successful synthesis of the targeted aromatic polyimide composites (Y. Meng, et al., J. Mater. Chem. A, 2014, 2, 10842; and C.-P. Constantin, et al., Polym. Int., 2015, 64, 361-372). Meanwhile, the intensities of the aforementioned PT characteristic peaks increase with increasing PT amount, from PI10PT to PI50PT. Furthermore, the spectra of the PI@PT composites are a superposition of the characteristic absorption peaks of PI and PT without generating additional new peaks, which demonstrates the non-covalent interaction between the PI core and PT coating, thus preserving the integrity of the redox-active carbonyl groups in PI or the electrochemical reactivity of the composite electrode.

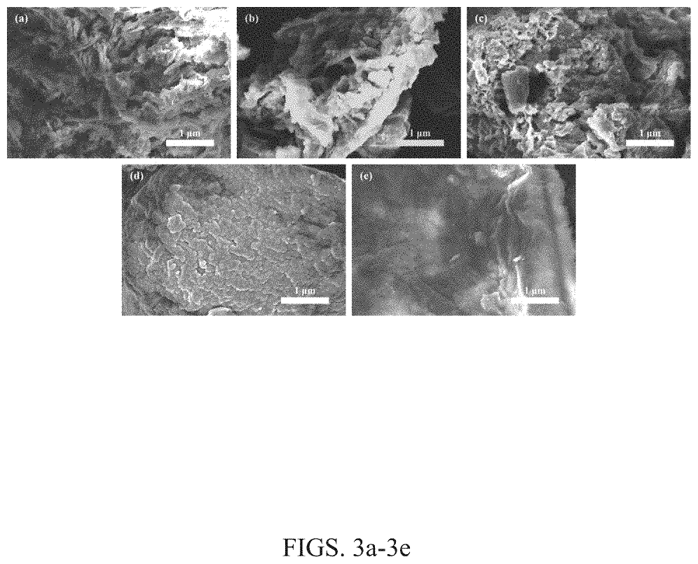

The surface morphologies of PI, PI10PT, PI30PT, PI50PT and pure PT were characterized by SEM, as shown in FIGS. 3a-3e. The SEM images are as follows: polyimide (FIG. 3a); polyimide coated with 10 wt % polythiophene (i.e., PI1 OPT, FIG. 3b); PI30PT (FIG. 3c); PI50PT (FIG. 3d); and polythiophene (FIG. 3e). The pristine PI particle shows an apparent surface porous structure (FIG. 3a). In contrast, the surface of pure PT particle is compact and smooth, without any porous structure (FIG. 3e). For the PI@PT composites, the surface porous structure of the PI particle gradually disappears with increasing amount of PT coating, as evidenced in FIGS. 3b-3d. As shown in FIG. 3d, the PT coating in the PI50PT sample is thick enough to cover the entire PI particle, which results in a compact and substantially non-porous structure, similar to that of pure PT (FIG. 3e). The compact and substantially non-porous morphology of PI50PT will impede the penetration of liquid electrolyte, adversely affecting the diffusion of lithium ions as well as rate capability as shown later. Thus, the compact and substantially non-porous morphology of PI50PT is not ideal for purposes of the present invention.

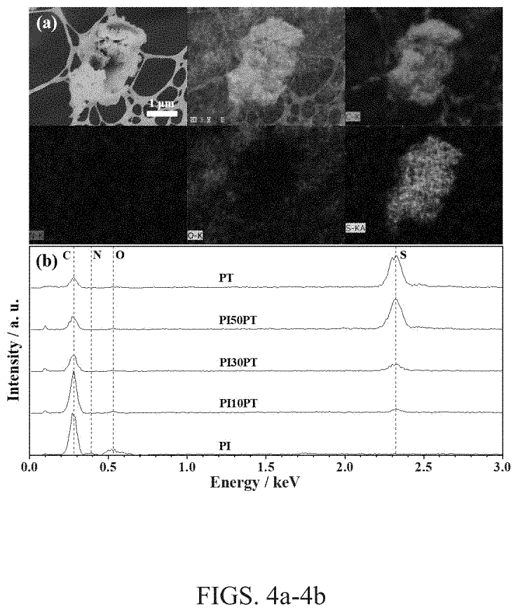

To further investigate the chemical structure of the polymeric composites, EDS elemental analysis was conducted, as shown in FIGS. 4a and 4b. FIG. 4a contains six panels of SEM images of PI30PT as follows: SEM image (top left), SEM image with total energy-dispersive x-ray spectroscopy (EDS) mapping of C, N, O, and S elements (top middle); SEM image with EDS mapping of C (top right); SEM image with EDS mapping of N (bottom left); SEM image with EDS mapping of O (bottom middle); and SEM image with EDS mapping of S (bottom right). The EDS mapping of PI30PT in FIG. 4a shows uniform distribution of carbon and sulfur, which confirms the presence of PT. However, barely no nitrogen and oxygen within the sample area was detected in the mapping scan, which can be attributed to the absence of PI on the surface of the PI30PT composite, which further confirms that PT was coated on the surface of PI. FIG. 4b shows the EDS spectra of PT, PI, PI10PT, PI30PT and PI50PT. The peaks of nitrogen and oxygen can be clearly seen in the PI sample, while they are hardly observed in the other composite samples. In contrast, the sulfur peak in the PI@PT composites gradually increases with increasing the content of PT. It is noted that the spectrum of the PI50PT sample is almost identical to that of pure PT, which suggests that the PI particles in PI50PT are totally covered by PT. These results further confirm the successful synthesis of the targeted polymer composites of PI@PT.

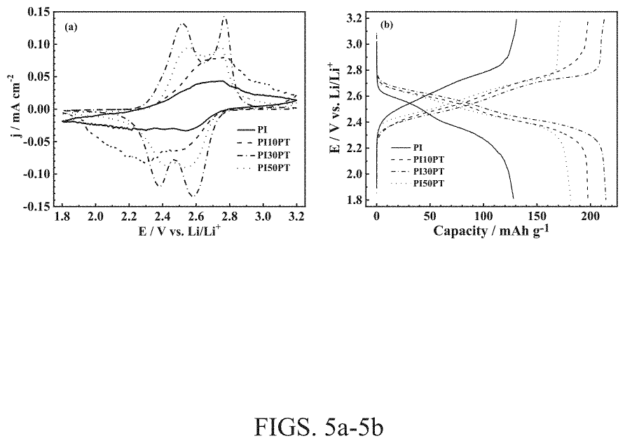

FIG. 5a shows cyclic voltammograms (CVs) of the PI, PI10PT, PI30PT and PI50PT composite electrodes in the voltage range of 1.8-3.2 V at a scan rate of 0.05 mV s⁻¹. Two pairs of well-resolved redox peaks can be observed for the PI30PT electrode involving two reduction peaks at 2.39 and 2.58 V and two corresponding oxidation peaks at 2.52 and 2.77 V, respectively. A reversible two-electron redox reaction is confirmed by the doublets during both lithiation and de-lithiation processes, which corresponds to a stepwise formation of radical anion and dianion (Z. Song, et al., Angew. Chem. Int. Ed., 2010, 49, 8444-8448). As a comparison, the corresponding doublets for both PI and PI10PT are not well-defined, which can be attributed to their low electronic conductivity due to lower (or zero) content of highly conductive PT coating, which results in slow charge transfer kinetics between the radical anion and the dianion (Z. Song, et al., Chem. Commun., 2009, DOI: 10.1039/b814515f, 448-450). Notably, the peak currents of PI50PT are much lower than those of PI30PT, which can be attributed to poor Li-ion diffusivity due to the greater thickness of the PT coating in PI50PT. Furthermore, the onset potentials of the first reduction peak and the first oxidation peak during the discharge/charge process are as follows: 2.41 and 2.75 V (for PI); 2.29 and 2.78 V (for PI10PT); 2.21 and 2.83 V (for PI30PT): and 2.28 and 2.80 V (for PI50PT). The higher potential during discharge and lower potential during charge for the PI30PT electrode suggest it has the lowest polarization among these polymeric electrodes, which results in high utilization efficiency of the polymer cathode and high specific capacity. Moreover, the CV of pristine PT shows no peaks in the voltage range of 1.8 V and 3.2 V, which indicates that the PT contribution in the PI@PT composites in the tested voltage range is only electron conductivity.

To further understand the effect of the polythiophene coating on the Li-ion diffusion in the electrodes, CVs of the PI, PI10PT, PI30PT and PI50PT composite electrode were taken at various scan rates in the range of 0.05-2.0 mV s⁻¹. The Li-ion diffusion coefficients were calculated using the Randles-Sevcik equation (Eqn. 1) (Z. H. Bi, et al., J. Mater. Chem. A, 2014, 2, 1818-1824; and M. Stromme, et al., Solid State Commun., 1995, 96, 151-154), as follows:

Iₚ=269000n^{3/2}AD^{1/2}Cv^{1/2} (2)

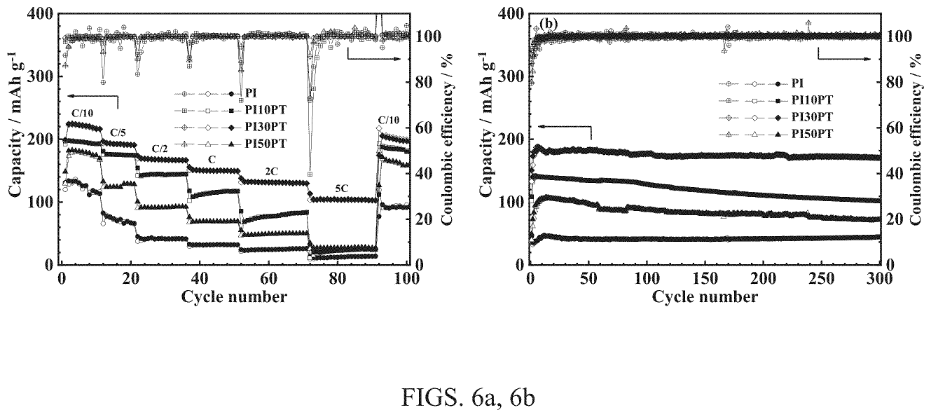

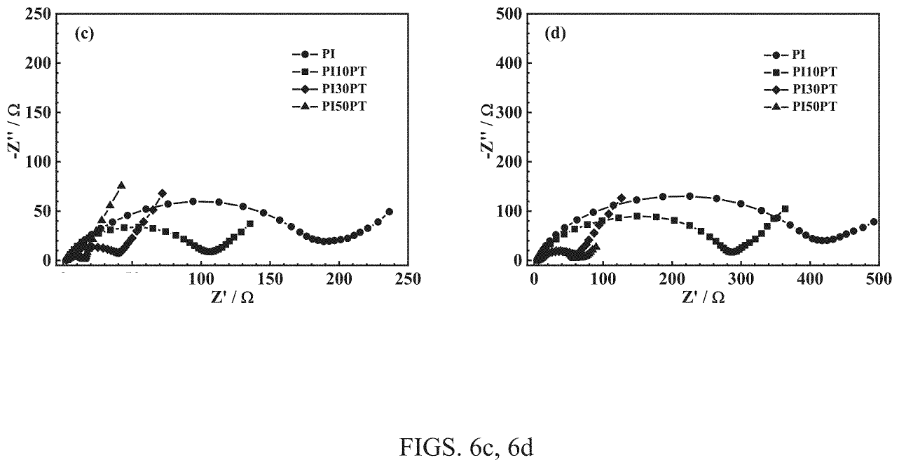

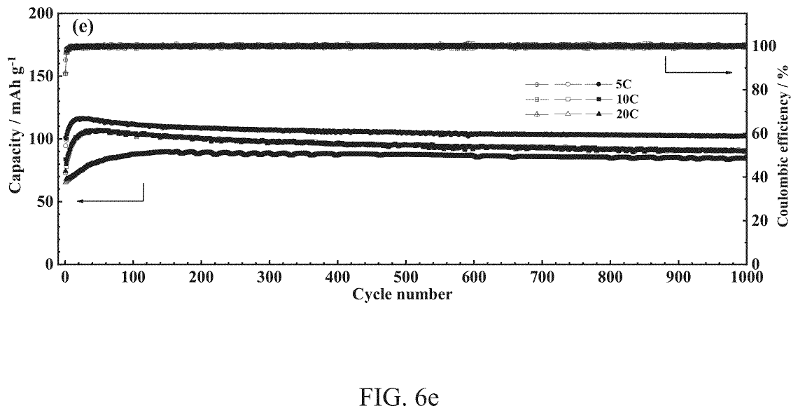

In Formula (2), Iₚ is the peak current (A), n is the electrons concentration per molecule during the redox reactions, A is the surface area of the electrodes (cm²), D is the diffusion coefficient of lithium ions (cm² s⁻¹), C is the bulk concentration of lithium ions in electrodes (mol cm⁻³) and v is the scan rate (V s⁻¹). A linear relationship between Iₚ and v^{1/2} was obtained. The diffusion coefficients of lithium ions were calculated according to the slopes. The diffusion coefficients of lithium ions in PI, PI10 PT, PI30PT and PI50PT are calculated as follows (for oxidation and reduction of each of the five samples, respectively): 6.39×10⁻¹³ and 8.35×10⁻¹³ cm² s⁻¹ (for PI); 4.73×10⁻¹¹ and 4.79×10⁻¹¹ cm² s⁻¹ (for PI10PT); 3.14×10⁻¹⁰ and 2.92×10⁻¹⁰ cm² s⁻¹ (for PI30PT) and 9.60×10⁻¹¹ and 7.08×10⁻¹¹ cm² s⁻¹ (for PI50PT). The lithium ion diffusion coefficient in the PI10PT electrode is almost two orders magnitude higher than that in the PI electrode, but it is still one order magnitude lower than that in the PI30PT electrode. Comparatively, the lithium ion diffusion coefficient in the PI30PT electrode is more than triple that in the PI50PT electrode, which is double that in the PI10PT electrode. These data confirm that the PI30PT electrode has the highest lithium diffusion coefficients, which is consistent with the rate performance shown in FIGS. 6a-6e, as discussed later on below.

FIG. 5b shows the galvanostatic charge/discharge profiles of the half-cells based on PI, PI10PT, PI30PT and PI50PT at a current rate of C/10. As expected from the CVs in FIG. 4a, a two-step charge/discharge process can be clearly observed for all the PI@PT composite materials. However, only a slope is observed for the PI-based cell during the charge process, which is attributed to the severe polarization due to its low electronic conductivity. These results are highly consistent with the CV analysis in FIG. 5a, which further confirms that the PI30PT electrode delivers low cell polarization and fast lithium reaction kinetics.

FIGS. 6a-6e compare the rate and cycling performance of the half-cells based on PI, PI10PT, PI30PT and PI50PT, as well as the EIS data of the cells before and after cycling. FIG. 6a shows charge-discharge capacities and coulombic efficiencies of the half-cells based on PI, PI10PT, PI30PT and PI50PT at different current rates. FIG. 6b shows charge-discharge capacities and coulombic efficiencies of the half-cells based on PI, PI10PT, PI30PT and PI50PT at a current rate of C/2. FIG. 6c shows electrochemical impedance spectra of the half-cells based on PI, PI10PT, PI30PT and PI50PT before cycling. FIG. 6d shows electrochemical impedance spectra of the half-cells based on PI, PI10 PT, PI30PT and PI50PT after 300 cycles at C/2. FIG. 6e shows charge-discharge capacities and coulombic efficiencies of the half-cells based on PI30PT at different current rates (hollow circles and solid spheres represent charge and discharge capacities, respectively, while hollow stars represent coulombic efficiencies in FIGS. 6a, 6b and 6e).

A common feature for all the polyimide based materials is the initial gradual increase of capacity, which can be attributed to the activation process due to the gradual penetration of the liquid electrolyte into the polymeric composite cathodes (C. Chen, et al., Electrochimica Acta, 2017, 229, 387-395; and S. R. Sivakkumar, et al., J. Electrochem. Soc., 2007, 154, A834). As shown in FIG. 6a, the PI30PT-based cell exhibits reversible capacities of ca. 216.8, 193.6, 169.1, 151.1, 132.2 and 104.7 mA h g⁻¹ at current rates of C/10, C/5, C/2, IC, 2C and 5C, respectively, with high coulombic efficiencies of 100% except the rate changing cycles. The capacity recovers back to 205.8 mAh g⁻¹ when the current rate is switched back to C/10, equivalent to a 95% capacity retention. As a comparison, the reversible capacities for the half-cells based on PI and PI10PT are 116.0, 67.0, 41.9, 32.0, 23.2, 11.4, 90.2 mA h g⁻¹ (for PI) and 192.5, 174.6, 143.1, 111.1, 71.1, 18.4, 183.4 mA h g⁻¹ (for PI10PT) at current rates of C/10, C/5, C/2, 1C, 2C, 5C, C/10, respectively.

The comparison of rate performance in FIG. 6a suggests that the PI30PT cathode has the best combination of electron conductivity and lithium reaction kinetics, consistent with its highest lithium diffusion coefficient. However, the reversible capacities of the PI50PT based cell are always lower than the PI10PT-based cell except at 5C, although the former has higher lithium diffusion coefficient than the latter. This is closely related to the thickness of the surface coating and the different surface morphology of the primary composite particles, as shown in FIGS. 3a-3e. Although the lithium diffusion coefficient in PI50PT is double that in PI10PT, in average the thickness of PT coating in PI50PT is about five-fold that in PI10PT; therefore, under the same current rate, lithium ions will reach the electroactive PI center faster in PI10PT than in PI50PT, which results in higher capacity in the former than in the latter.

Besides good rate performance, the PI30PT based half-cell also exhibits better cycling stability, as shown in FIG. 5b. After a gradual increase within the initial few cycles, the reversible capacity of the PI30PT based cell reached a high value of 186.6 mA h g⁻¹ at a current rate of C/2. Then it decreased slowly with cycling and is still as high as 170.9 mA h g⁻¹ after 300 cycles, resulting in a high capacity retention of 92%. In contrast, the reversible capacities of the PI10PT- and PI50PT-based cells are 140.1 and 106.6 mA h g⁻¹ after the first few activation cycles, and then decrease gradually to 101.5 and 71.6 mA h g⁻¹ after 300 cycles, exhibiting capacity retentions of 72% and 67%, respectively. The impressive cycling stability of the PI30PT-based cell is also supported by the EIS data before and after cycling, as shown in FIGS. 6c and 6d, respectively. The total cell impedance before cycling continually decreases with increasing PT content, which is consistent with the excellent electronic conductivity of PT. After 300 cycles, the total cell impedance increases. However, it only increases from 40.8Ω before cycling to 57.8Ω after 300 cycles for the PI30PT-based cell, whereas it increases from 15.2, 107.3, and 188.8Ω before cycling to 58.8, 286.7, and 417.4Ω after 300 cycles for the PI50PT, PI10PT and PI based cells, respectively.

To further investigate the potential practical application of the PI30PT composite material, long cycling performance under high current rates were also evaluated, as shown in FIG. 6e. The reversible capacities are 116.3, 107.1 and 89.6 mA h g⁻¹ at high current rates of 5C, 10C and 20C, respectively, with coulombic efficiencies all near 99.8%. After 1000 cycles, reversible capacities are still as high as 102.5, 90.8 and 84.3 mA h g⁻¹ at 5C, 10C and 20C, leading to high capacity retention of 88%, 85% and 94%, respectively. The superior cycling performance of the PI30PT-based cells can be attributed to the optimal content of PT, which not only provides good electron conductivity but also successfully acts as the protection shell to maintain the structural integrity of the polyimide composite, preventing it from decomposition and dissolving into the liquid electrolyte during cycling via the strong π-π interactions between the polyimide matrix and the PT coating.

In summary, novel polymeric composites based on coating aromatic polyimides with electron conducting polythiophene have been prepared by a facile in situ chemical oxidation polymerization approach for application in rechargeable lithium-ion batteries. The optimal PT coating, 30 wt % (PI30PT), enables high electron conductivity and fast lithium reaction kinetics. Therefore, the PI30PT composite electrode delivers not only a reversible specific capacity of 216.8 mA h g⁻¹ at a low current rate of C/10 but also a remarkable high-rate cyclability, thus achieving a high capacity of 89.6 mA h g⁻¹ at 20C with capacity retention of 94% after 1000 cycles. These superior electrochemical properties result from the elaborate synergy of stable redox reversibility of PI and high electronic conductivity of PT. Overall, PI30PT, in particular, has been shown to be a promising cathode material candidate for practical application in “green and sustainable” lithium ion batteries.

While there have been shown and described what are at present considered the preferred embodiments of the invention, those skilled in the art may make various changes and modifications which remain within the scope of the invention defined by the appended claims.

What is claimed is:

1. A composite material comprising particles containing (i) a core comprising an organic polymer material that is ion-permeable, not electron conductive, and possesses reversible electrochemical activity, and (ii) an electron conductive polymer coated onto and encapsulating said core.

2. The composite material of claim 1, wherein said organic polymer material in said core is selected from the group consisting of aromatic polyimide, polyquinone, and radical-containing polymers.

3. The composite material of claim 1, wherein said organic polymer material in said core is an aromatic polyimide composition.

4. The composite material of claim 3, wherein said aromatic polyimide has the following general structure: 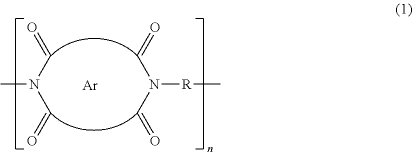
wherein Ar represents an aromatic ring or ring system within the bounds of the two arcs depicted in Formula (1), each arc connected to carbonyl groups depicted in Formula (1); R represents a bond or a hydrocarbon linking group; and n represents an integer of at least 10.

5. The composite material of claim 4, wherein R is a bond.

6. The composite material of claim 4, wherein R is a hydrocarbon linking group.

7. The composite material of claim 6, wherein said hydrocarbon linking group is an alkylene, alkenylene, or aromatic linking group.

8. The composite material of claim 4, wherein Ar is an aromatic ring system containing at least two aromatic rings fused together.

9. The composite material of claim 4, wherein the aromatic polyimide of Formula (1) is selected from the group consisting of:

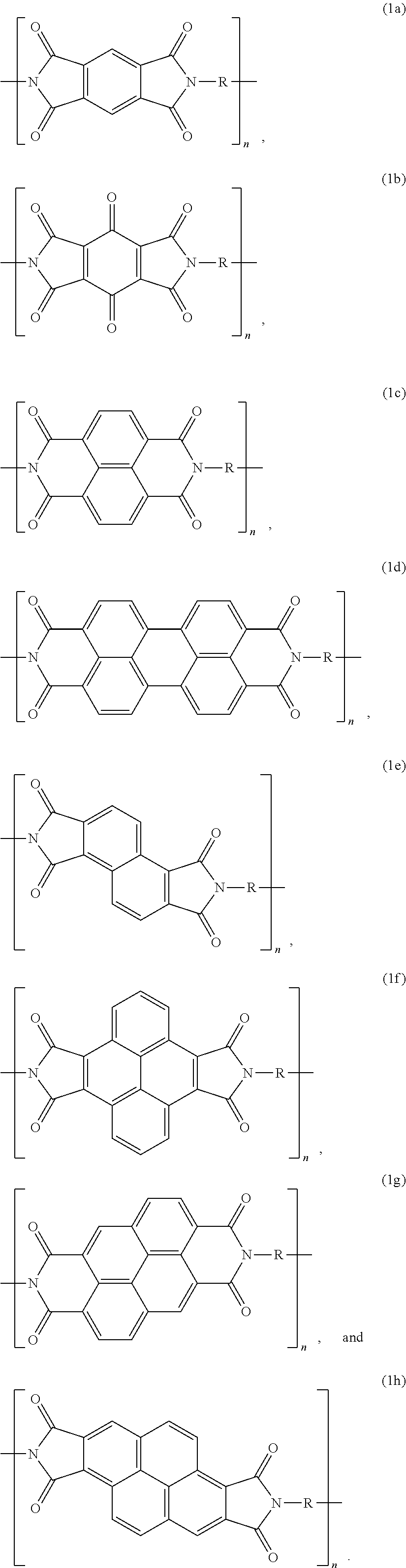

10. The composite material of claim 1, wherein said electron conductive polymer is present in an amount of 1-50 wt % by weight of the electron conductive polymer and core.

11. The composite material of claim 1, wherein said electron conductive polymer is present in an amount of 1-40 wt % by weight of the electron conductive polymer and core.

12. The composite material of claim 1, wherein said electron conductive polymer is aromatic.

13. The composite material of claim 1, wherein said electron conductive polymer is selected from the group consisting of polythiophene, poly(3,4-ethylenedioxythiophene), polypyrrole, polyaniline, polyacetylene, poly(p-phenylene vinylene), poly(3-vinylperylene), alkyl-substituted derivatives thereof, hydrophilized derivatives thereof, and copolymers thereof.

14. A lithium-ion battery comprising:
(a) an anode;
(b) a cathode; and
(c) a lithium-containing electrolyte in contact with said anode and cathode;
wherein said cathode contains a composite material comprising particles containing (i) a core comprising an organic polymer material that is ion-permeable, not electron conductive, and possesses reversible electrochemical activity, and (ii) an electron conductive polymer coated onto and encapsulating said core.

15. The lithium-ion battery of claim 14, wherein said organic polymer material in said core is selected from the group consisting of aromatic polyimide, polyquinone, and radical-containing polymers.

16. The lithium-ion battery of claim 14, wherein said organic polymer material in said core is an aromatic polyimide composition.

17. The lithium-ion battery of claim 16, wherein said aromatic polyimide has the following general structure: 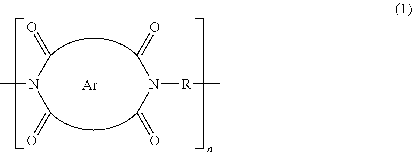
wherein Ar represents an aromatic ring or ring system within the bounds of the two arcs depicted in Formula (1), each arc connected to carbonyl groups depicted in Formula (1); R represents a bond or a hydrocarbon linking group; and n represents an integer of at least 10.

18. The lithium-ion battery of claim 14, wherein said electron conductive polymer is aromatic.

19. The lithium-ion battery of claim 14, wherein said electron conductive polymer is selected from the group consisting of polythiophene, poly(3,4-ethylenedioxythiophene), polypyrrole, polyaniline, polyacetylene, and poly(p-phenylene vinylene), alkyl-substituted derivatives thereof, hydrophilized derivatives thereof, and copolymers thereof.

20. The lithium-ion battery of claim 14, wherein said electron conductive polymer is present in an amount of 1-50 wt % by weight of the electron conductive polymer and core.

21. The lithium-ion battery of claim 14, wherein said electron conductive polymer is present in an amount of 1-40 wt % by weight of the electron conductive polymer and core.

22. A capacitor comprising:
(a) two electrodes;
(b) an ion-permeable membrane between the two electrodes; and
(c) an electrolyte in contact with the two electrodes;
wherein at least one of said two electrodes contains a composite material comprising particles containing (i) a core comprising an organic polymer material that is ion-permeable, not electron conductive, and possesses reversible electrochemical activity, and (ii) an electron conductive polymer coated onto and encapsulating said core.

23. The capacitor of claim 22, wherein said capacitor is a supercapacitor.

24. The capacitor of claim 22, wherein said organic polymer material in said core is selected from the group consisting of aromatic polyimide, polyquinone, and radical-containing polymers.

25. The capacitor of claim 22, wherein said organic polymer material in said core is an aromatic polyimide composition.

26. The capacitor of claim 25, wherein said aromatic polyimide has the following general structure: 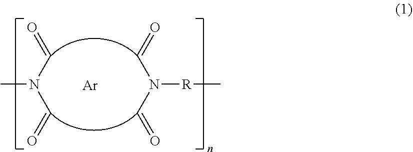
wherein Ar represents an aromatic ring or ring system within the bounds of the two arcs depicted in Formula (1), each arc connected to carbonyl groups depicted in Formula (1); R represents a bond or a hydrocarbon linking group; and n represents an integer of at least 10.

27. The capacitor of claim 22, wherein said electron conductive polymer is aromatic.

28. The capacitor of claim 22, wherein said electron conductive polymer is selected from the group consisting of polythiophene, poly(3,4-ethylenedioxythiophene), polypyrrole, polyaniline, polyacetylene, and poly(p-phenylene vinylene), alkyl-substituted derivatives thereof, hydrophilized derivatives thereof, and copolymers thereof.

29. The capacitor of claim 22, wherein said electron conductive polymer is present in an amount of 1-50 wt % by weight of the electron conductive polymer and core.

30. The capacitor of claim 22, wherein said electron conductive polymer is present in an amount of 1-40 wt % by weight of the electron conductive polymer and core.
